(19) United States
(12) Patent Application Publication
(10) Pub. No.: US 2011/0292282 A1
(43) Pub. Date: Dec. 1, 2011

(54) INFORMATION PROCESSING DEVICE, INFORMATION PROCESSING METHOD, AND INFORMATION PROCESSING SYSTEM

(76) Inventor: Masaaki Isozu, Tokyo (JP)

(21) Appl. No.: 13/112,295

(22) Filed: May 20, 2011

(30) Foreign Application Priority Data
Jun. 1, 2010 (JP) P2010-126018

(51) Int. Cl. H04N 5/445

(52) U.S. Cl. 348/563; 348/E05.099

(57) ABSTRACT

A method is provided for controlling devices. The method comprises receiving user input indicating a request to connect to a controllable device. The method further comprises transmitting information to a plurality of controllable devices having indicators, the transmitted information including a command for causing the controllable devices to display, on the indicators, identifiers corresponding to the controllable devices.

### CROSS-REFERENCE TO RELATED APPLICATIONS

The present application claims priority to and contains subject matter related to that disclosed in Japanese Priority Patent Application JP 2010-126018 filed in the Japan Patent Office on Jun. 1, 2010, the entire content of which is hereby incorporated by reference.

### BACKGROUND

1. Technical Field

The present disclosure relates to an information processing device, an information processing method, and an information processing system for enabling controlled equipment serving as a manipulation target to be manipulated.

2. Description of the Related Art

In general, controlled equipment (hereinafter, also simply referred to as “equipment”) such as a television is manipulated through an input device in which a manipulation method is limitedly performed, for example, a remote controller or the like. However, if a complex input in which a mouse or a keyboard is necessary, for example, a character input, is performed, the input device as described above is inconvenient. As a more convenient input device, for example, a mobile terminal is used for manipulation control of equipment such as a television. The mobile terminal has high manipulability even in manipulations such as the character input and object selection. A remote desktop is also an example of using the mobile terminal as the input device.

For example, as disclosed in Japanese Patent Application Laid-Open No. 2009-17404 as technology for enabling controlled equipment to be remotely manipulated, remote manipulation of the controlled equipment may be easily performed by an information processing device by transmitting manipulation information of a user to the controlled equipment using a communication card. For example, technology of performing remote manipulation from a client in a relation between a server and the client connected to a network is disclosed in Japanese Patent Application Laid-Open No. 2009-76011.

### TECHNICAL PROBLEM

However, in order to use the mobile terminal as the input device of the controlled equipment, the mobile terminal must usually be registered in advance at an equipment side, and an equipment name or the like must be input or selected exactly in the mobile terminal. Thus, everyone may not simply use the mobile terminal as the input device of the controlled equipment since a user needs as much knowledge on performing setting manipulation to a certain extent as possible in advance.

In a case where the mobile terminal is simply used as the input device, there is also a risk in that an erroneous operation may occur since it is vague whether the mobile terminal is manipulated or whether the equipment is manipulated. Since so-called mirroring in which a screen configuration of the controlled equipment is directly transmitted to the mobile terminal is performed in the remote desktop, there is a problem in that an operation is heavy. Further, there is a problem in terms of security in that all manipulations are taken over when a failure occurs since all screens of the equipment are displayed on the mobile terminal in the remote desktop.

Upon initial setting, manipulation may not be easy since there is no information for connecting a communication card and controlled equipment by the user in Japanese Patent Application Laid-Open No. 2009-17404 described above. In Japanese Patent Application Laid-Open No. 2009-76011 described above, there is no means for selecting a manipulation server since the manipulation server is decided in advance from a client.

In light of the foregoing, it is desirable to provide a novel and improved information processing device, information processing method, and information processing system that can use control equipment as an input device of controlled equipment in simple manipulation.

### SUMMARY

Accordingly, there is provided an apparatus for controlling devices. The apparatus comprises an input unit for receiving user input indicating a request to connect to a controllable device. The apparatus further comprises a communication unit for transmitting information to a plurality of controllable devices having indicators, the transmitted information including a command for causing the controllable devices to display, on the indicators, identifiers corresponding to the controllable devices.

In another aspect, there is provided a method for controlling devices. The method comprises receiving user input indicating a request to connect to a controllable device. The method further comprises transmitting information to a plurality of controllable devices having indicators, the transmitted information including a command for causing the controllable devices to display, on the indicators, identifiers corresponding to the controllable devices.

In another aspect, there is provided a tangibly embodied non-transitory computer-readable storage medium storing instructions which, when executed by a processor, cause a computer to perform a method controlling devices. The method comprises receiving user input indicating a request to connect to a controllable device. The method further comprises transmitting information to a plurality of controllable devices having indicators, the transmitted information including a command for causing the controllable devices to display, on the indicators, identifiers corresponding to the controllable devices.

In another aspect, there is provided a system for controlling devices. The system comprises a controlling unit for receiving user input indicating a request to connect to a controllable unit, and transmitting information to a plurality of controllable units having indicators, the transmitted information including a command for causing the controllable units to display, on the indicators, identifiers corresponding to the controllable units. The system further comprises a controllable unit for receiving the transmitted information including the command from a controlling unit, and displaying an identifier of the controllable unit on an indicator of the controllable unit, in response to the command.

According to the embodiments described above, there are provided an information processing device, an information processing method, and an information processing system that can use control equipment as an input device of controlled equipment in simple manipulation.

### BRIEF DESCRIPTION OF THE DRAWINGS

FIG. 1 is an explanatory diagram showing a processing overview of an information processing system according to an exemplary embodiment.

FIG. 2 is a block diagram showing a functional configuration of the information processing system according to the same embodiment.

FIG. 3 is a timing chart showing the entire flow of manipulation establishment processing between a mobile terminal and equipment by the information processing system.

FIG. 4 is a flowchart showing processing from pressing of a connection button to displaying of connection information at the mobile terminal side.

FIG. 5 is an explanatory diagram showing an example of a message format.

FIG. 6 is an explanatory diagram showing an example of a state in which an identifier is displayed on a television and the mobile terminal.

FIG. 7 is an explanatory diagram showing a state in which a user input directed to the mobile terminal is synchronized with manipulation of the television after the television is connected to the mobile terminal.

FIG. 8 is a conceptual diagram showing a screen configuration example of the mobile terminal.

FIG. 9 is a flowchart showing processing of the mobile terminal during a synchronization mode according to the same embodiment.

FIG. 10 is an explanatory diagram showing another screen configuration example of the mobile terminal.

FIG. 11 is an explanatory diagram showing a radio wave arrival range of the mobile terminal.

FIG. 12 is a flowchart showing processing of changing the radio wave arrival range in the mobile terminal.

FIG. 13 is a block diagram showing a hardware configuration example of the mobile terminal according to the same embodiment.

### DETAILED DESCRIPTION OF THE EMBODIMENT(S)

Exemplary embodiments will now be described in detail with reference to the appended drawings. In this specification and the drawings, elements having substantially the same functional configurations are denoted by the same reference numerals, and redundant description thereof is omitted.

Description is given in the following order.

1. Processing Overview of Information Processing System

2. Configuration of Information Processing System

3. Manipulation Establishment Processing between Mobile Terminal and Equipment by Information Processing System

3-1. Processing from Pressing of Connection Button and Displaying of Connection Information

3-2. Processing from Displaying of Connection Information to User Input Synchronization/Release

4. Modified Example

5. Hardware Configuration Example

### 1. Processing Overview of Information Processing System

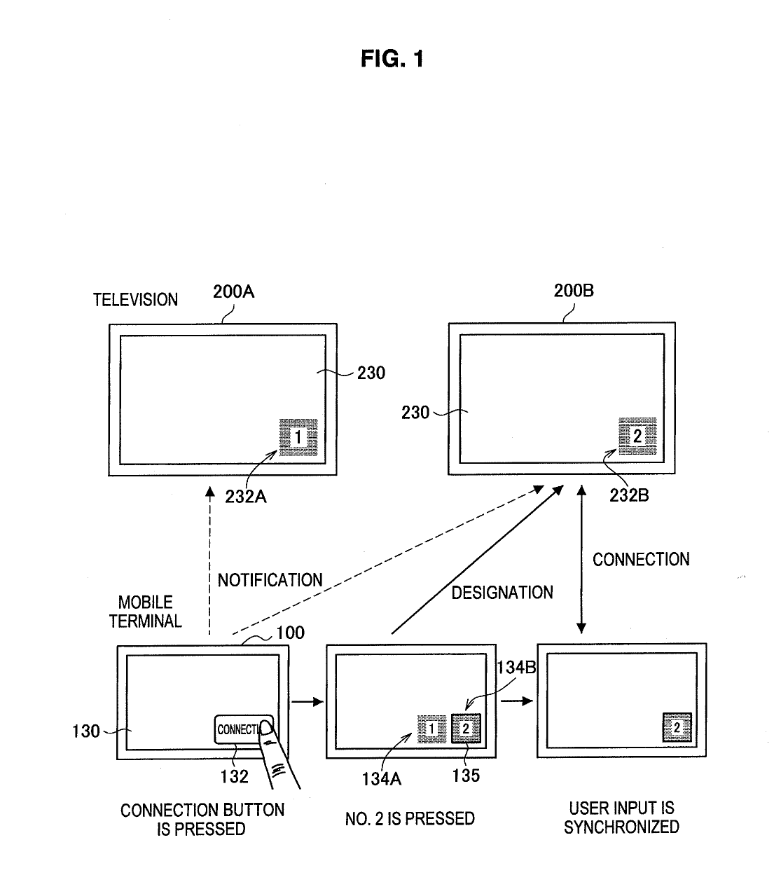

First, the processing overview of the information processing system in a mobile terminal 100, which is control equipment having an information processing device, and a television 200, which is controlled equipment, according to an exemplary embodiment will be described based on FIG. 1. FIG. 1 is an explanatory diagram showing the processing overview of the information processing system according to this embodiment.

The information processing system according to this embodiment includes the controlled equipment and the control equipment for manipulating the controlled equipment. The controlled equipment is described as the television 200, and the mobile terminal 100, which is the control equipment, is described, for example, as a notebook-sized personal computer or a mobile phone, a tablet type terminal, or the like in this embodiment, but embodiments are not limited to this example. For example, it is preferable that the controlled equipment be a visual display unit capable of visually displaying information, and it is preferable that the control equipment be a portable terminal.

The information processing system according to this embodiment is intended to perform a complex input operation on the television 200 for which a general keyboard or mouse is necessary using the mobile terminal 100 as the input device. In this case, the mobile terminal 100 can be used as the input device of the television 200 by mapping the mobile terminal 100 to the television 200.

In the information processing system of this embodiment as shown in FIG. 1, the mobile terminal 100 first performs processing of recognizing equipment capable of being manipulated by the mobile terminal 100. For example, the user transmits a notification message to neighboring equipments by wireless communication by pressing a connection button 132 displayed on the display unit 130 of the mobile terminal 100 (notification processing). Two televisions 200A and 200B receiving the notification message display equipment identification information unique to the respective equipments like objects 232A and 232B on screens of notification units 230 (here, also used as display units). Simultaneously, objects 134A and 134B corresponding to the equipment identification information of the televisions 200A and 200B are also displayed on the display unit 130 of the mobile terminal 100.

The user selects equipment to be manipulated by the mobile terminal 100 by selecting any one of the objects 134A and 134B displayed on the display unit 130. For example, if the object 134B for selecting the television 200B is selected, a selection mark 135 indicating the selection of the object 134B is displayed. The mobile terminal 100 notifies the television 200B of the fact that the television 200B is selected as a manipulation target by transmitting a connection message (designation processing). The television 200B receives the connection message, so that a connection between the television 200B and the mobile terminal 100 is established and the user input (for example, cursor manipulation, a click, or the like) directed to the television 200B by the mobile terminal 100 is synchronized.

Hereinafter, the configuration of the information processing system as described above and processing thereby will be described in detail.

### 2. Configuration of Information Processing System

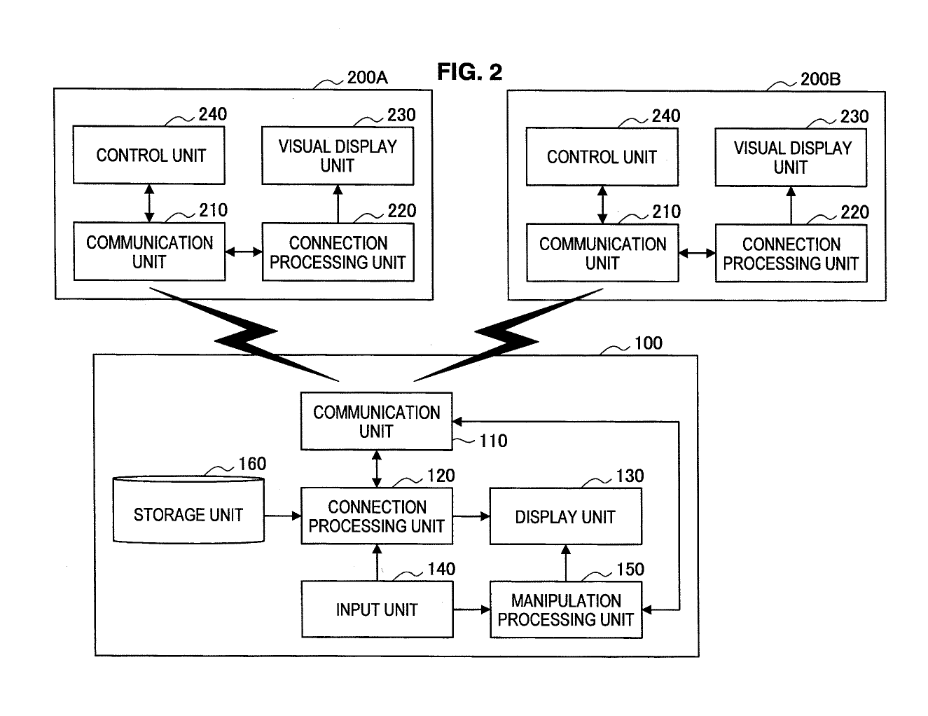

First, a functional configuration of the information processing system according to this embodiment will be described based on FIG. 2. FIG. 2 is a block diagram showing the functional configuration of the information processing system according to this embodiment. In FIG. 2, only functional units necessary for enabling the mobile terminal 100 to manipulate manipulation target equipment are disclosed. Therefore, a processing unit for performing an original function of the mobile terminal 100 or a processing unit for displaying a program or the like on the televisions 200A and 200B is omitted, but it is assumed that they are performed by existing methods. Furthermore, as used herein the term “unit” may be a software module, a hardware module, or a combination of a software module and a hardware module.

As described with reference to FIG. 1, the information processing system includes the televisions 200A and 200B, which are controlled equipment, and the mobile terminal 100, which is control equipment for manipulating the televisions 200A and 200B.

The mobile terminal 100 includes a communication unit 110, a connection processing unit 120, a display unit 130, an input unit 140, a manipulation processing unit 150, and a storage unit 160.

The communication unit 110 transmits/receives information to/from the controlled equipment. Communication by the communication unit 110 is performed by wireless communication. As a wireless communication scheme, for example, WiFi (registered trademark), Bluetooth (registered trademark), Zigbee (trademark), or the like may be used, but embodiments are not limited to these examples. Based on an instruction of the connection processing unit 120, the communication unit 110 transmits information to the televisions 200A and 200B, and receives information from the televisions 200A and 200B.

The connection processing unit 120 is a processing unit that functions to establish connections between the mobile terminal 100 and the televisions 200A and 200B. The connection processing unit 120 transmits a notification message to the televisions 200A and 200B via the communication unit 110 based on a connection instruction input from a user, and determines whether or not a connection to the mobile terminal 100 is possible from its response results. The connection processing unit 120 causes the display unit 130 to display a device determined to be connectable to the mobile terminal 100. If the user inputs information for selecting equipment serving as a manipulation target from the input unit 140, the connection processing unit 120 transmits a connection message to the manipulation target equipment via the communication unit 110. The connection processing unit 120 establishes a connection between the mobile terminal 100 and connection target equipment by receiving a connection response message to the connection message from the manipulation target equipment.

The display unit 130 displays, for example, information based on an original function of the mobile terminal 100 such as a phone number, mail, or content, an object indicating equipment of a manipulation target candidate (or manipulation target), or the like. As the display unit 130, for example, a liquid crystal display, an organic EL display, or the like may be used.

The input unit 140 is an input unit for allowing the user to input manipulation information, and, for example, a button, a switch, a lever, or the like may be used thereas. A touch pad can be used as the input unit 140, and a touch panel may be configured to be stacked and provided with the display unit 130. In this embodiment, the touch pad is used as the input unit 140, and is provided so that manipulation information can be input by manipulating information displayed on the display unit 130 by a finger or the like.

After a connection between the mobile terminal 100 and the manipulation target equipment is established, the manipulation processing unit 150 performs manipulation processing for the manipulation target equipment in the mobile terminal 100. Based on the manipulation information input from the input unit 140, the manipulation processing unit 150 makes a manipulation instruction directed to the manipulation target equipment via the communication unit 110. If there is a response to the manipulation instruction from the manipulation target equipment, processing corresponding to the response is performed in the manipulation processing unit 150, and information regarding the response is displayed on the display unit 130, if necessary.

The storage unit 160 stores information to be used for establishing a connection between the mobile terminal 100 and the controlled equipment. For example, an address list of equipments capable of being manipulated by the mobile terminal 100 is stored in the storage unit 160. The information to be stored in the storage unit 160 may be preset or updated at any time, if necessary.

On the other hand, the televisions 200A and 200B include a communication unit 210, a connection processing unit 220, a visual display unit 230, and a control unit 240. Since functional configurations of the televisions 200A and 200B are the same as each other, only the television 200A will be described below.

The communication unit 210 transmits/receives information to/from the control equipment. Communication by the communication unit 210 is performed by the wireless communication as described above. The communication unit 210 receives information transmitted by the mobile terminal 100, and transmits information to the mobile terminal 100 based on an instruction of the connection processing unit 220 or the control unit 240.

The connection processing unit 220 is a processing unit having a function for establishing a connection to the mobile terminal 100. Upon receipt of a notification message transmitted from the mobile terminal 100, the connection processing unit 220 transmits a notification response message to the mobile terminal 100 via the communication unit 210. In this case, the connection processing unit 220 displays equipment identification information of the television 200A, which is the controlled equipment on the visual display unit 230. Upon receipt of a connection message transmitted from the mobile terminal 100, the connection processing unit 220 transmits a connection response message to the mobile terminal 100 via the communication unit 210.

The visual display unit 230 visually notifies the user of the equipment identification information of the controlled equipment. For example, a display unit such as a liquid crystal display or an organic EL display, a light emitting unit such as an LED, or the like is used as the visual display unit 230. If the visual display unit 230 is the display unit, the visual display unit 230 may also be used as a display that displays a program or the like, or may be a display provided separately therefrom.

After the connection between the mobile terminal 100 and the manipulation target equipment is established, the control unit 240 controls the equipment based on the manipulation information transmitted from the mobile terminal 100. For example, the control unit 240 performs processing of changing a display program, processing of a volume, or processing of changing setting information based on the manipulation information. If necessary, the control unit 240 can notify the mobile terminal 100 of manipulation control information.

### 3. Manipulation Establishment Processing Between Mobile Terminal and Equipment by Information Processing System

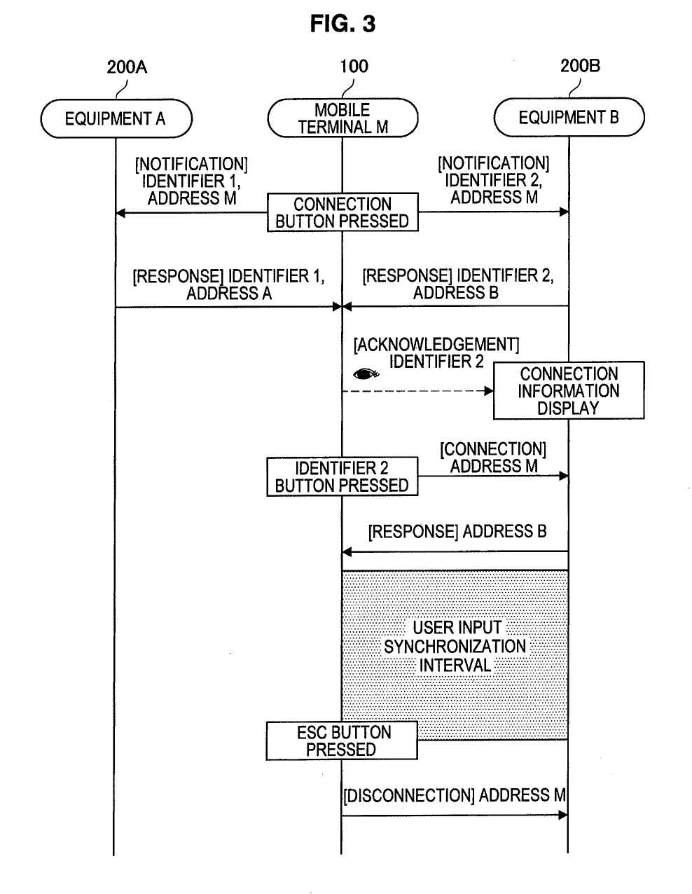

Next, the manipulation establishment processing between the mobile terminal and the equipment by the information processing system according to this embodiment will be described based on FIGS. 3 to 9. The entire flow of the manipulation establishment processing between the mobile terminal and the equipment by the information processing system is shown in FIG. 3. In FIG. 3, the mobile terminal 100 of FIG. 1 is shown as a mobile terminal M, the television 200A of FIG. 1 is shown as equipment A, and the television 200B is shown as equipment B. Hereinafter, addresses of the mobile terminal 100, the television 200A, and the television 200B are respectively designated as an address M, an address A, and an address B, and identifiers of the television 200A and the television 200B are respectively designated as an identifier 1 and an identifier 2.

[3-1. Processing from Pressing of Connection Button to Displaying of Connection Information]

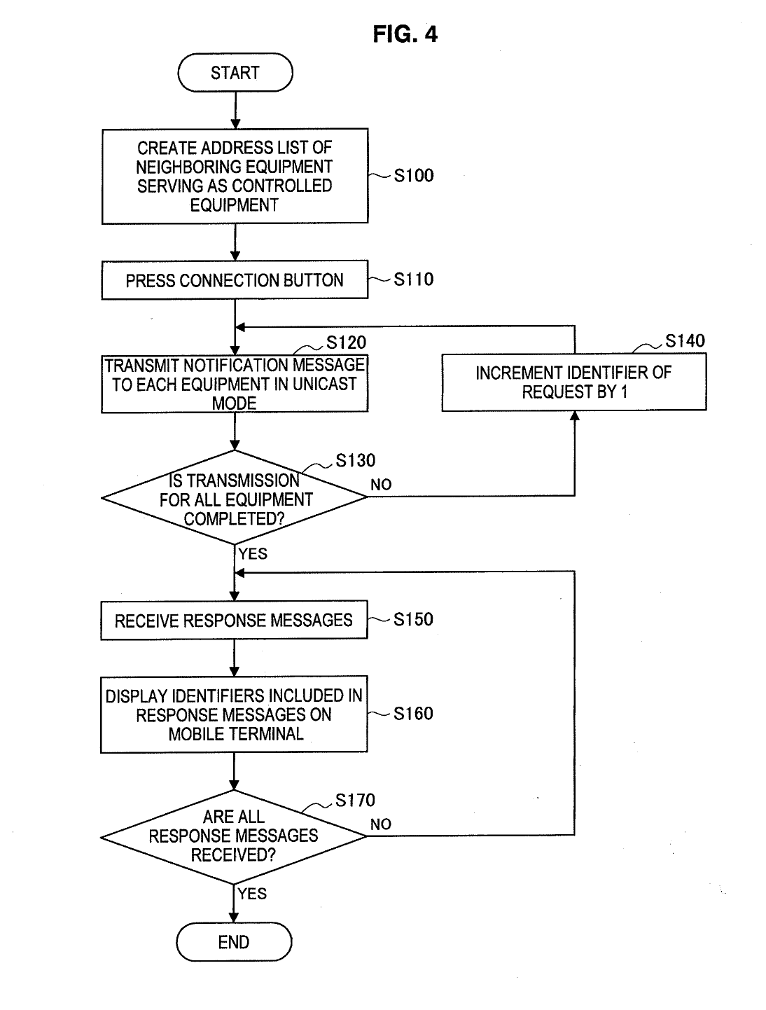

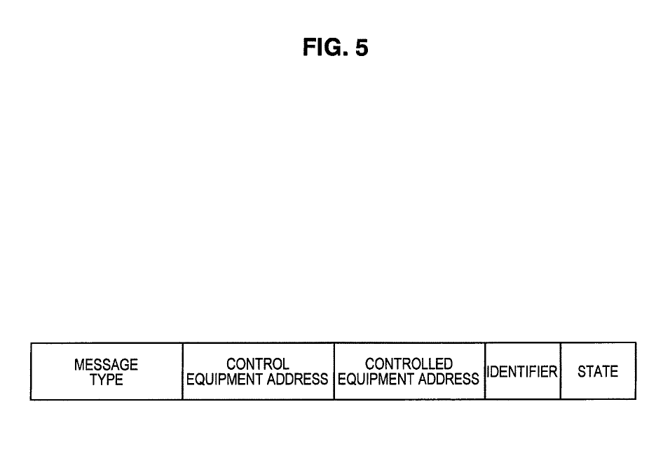

First, the processing from the pressing of the connection button to the displaying of the connection information will be described based on FIGS. 3, 4, and 5. FIG. 4 is a flowchart showing the processing from the pressing of the connection button to the displaying of the connection information at the mobile terminal side. FIG. 5 is an explanatory diagram showing an example of a message format.

In this embodiment, a connection button 132 displayed on the mobile terminal 100 shown in FIG. 1 is pressed, so that a notification message is transmitted to each controlled equipment and the manipulation establishment processing between the mobile terminal and the equipment is started by the information processing system. Previously, as shown in FIG. 4, the mobile terminal 100 acquires addresses of equipments to which the notification message is transmitted and creates an address list in advance (S100). The equipment address list may be created using, for example, a simple service discovery protocol (SSDP). The address M of the mobile terminal 100 and the addresses A and B of the controlled equipments are information capable of being uniquely identified, and, for example, IP addresses, MAC addresses, addresses of upper layers assigned to the mobile terminal 100 and the equipments 200A and 200B, or the like can be used.

If the user presses the connection button (S110), the mobile terminal 100 transmits notification messages to neighboring terminals by wireless communication so as to search for connectable controlled equipments (S120). The notification messages are transmitted to the controlled equipments in a unicast mode. The notification message includes at least the address M of the mobile terminal 100, which is a message transmission source, and an identifier, which is identification information of transmission destination equipment.

FIG. 5 shows a typical message format used in the notification message, the response message, or the like. As shown in FIG. 5, the message includes a message type, a control equipment address, a controlled equipment address, an identifier, a communication state, and the like. The message type is information indicating a type of message, and, for example, is information of a “notification,” a “response,” an “acknowledgement,” or a “disconnection” shown in FIG. 3. In this embodiment, the control equipment address is the address M of the mobile terminal 100, and controlled equipment addresses are the addresses A and B of the equipments 200A and 200B.

Identifiers are information to be displayed on the visual display units 230 of the respective controlled equipments 200A and 200B. In this embodiment, numbers are used as the identifiers. For example, the mobile terminal 100 assigns numbers incremented by one in order of notification message transmission as identifiers to respective equipments. As such, it is preferable that the identifiers be different information between the controlled equipments 200A and 200B. Numbers are used for simplicity as shown in FIG. 1 in this embodiment, but embodiments are not limited to this example. It is possible to use information capable of being easily recognized such as a character string, an icon, or a combination thereof. In the communication state, information of whether or not message transmission/reception is successful is recorded.

The connection processing unit 120 of the mobile terminal 100 recognizes whether or not notification messages are transmitted to all equipments, which are manipulation target candidates (S130). If there is equipment to which the notification message is not yet transmitted, the message is transmitted to the next equipment by incrementing the identifier by 1 (S140). That is, the processing of steps S120 to S140 is repeated until the notification messages are transmitted to all equipments. If the notification messages are transmitted to all the equipments, it waits for a response message to be received from each equipment.

On the other hand, the equipments 200A and 200B receiving the notification messages from the mobile terminal 100 transmit response messages to the mobile terminal 100. In this case, the respective equipments 200A and 200B display identifiers on the visual display units 230. For example, the identifier “1” is displayed on the visual display unit 230 of the equipment 200A as an object, and the identifier “2” is displayed on the visual display unit 230 as an object. The respective equipments 200A and 200B transmit the response messages to the mobile terminal 100. The response message includes its own address and identifier (that is, the address A and the identifier 1 for the equipment 200A or the address B and the identifier 2 for the equipment 200B).

If the mobile terminal 100 receives the response messages from the respective equipments 200A and 200B (S150), the identifiers of the respective equipments included in the response messages are displayed on the display unit 130 (S160). Objects of the identifier “1” of the equipment 200A and the identifier “2” of the equipment 200B are displayed on the display unit 130 of the mobile terminal 100, for example, as shown in the lower center of FIG. 1. The identifiers may be displayed using a global notification system for use in various operating systems.

The mobile terminal 100 confirms whether or not all response messages are received (S170). If there is a response message that is not yet received, the processing from step S150 is repeated. On the other hand, if it is determined that all messages are received in step S170, it waits for input manipulation to be received from the user. The above processing from the pressing of the connection button to the displaying of the connection information is terminated. In the step in which the processing of step S170 is terminated, a state in which an identifier of equipment capable of being manipulated by the mobile terminal 100 is displayed on the display unit 130 is reached.

In the example shown in the lower center of FIG. 1, it is seen that the mobile terminal 100 can manipulate the two equipments 200A and 200B. At this time, since their own identifiers are also displayed on the visual display units 230 of the respective equipments 200A and 200B, the user can visually recognize the identifiers of the respective equipments. For example, the objects 134A and 134B of the identifiers displayed on the display unit 130 of the mobile terminal 100 may function as selection buttons for selecting a manipulation target. In this case, the user may decide on equipment to be manipulated by the mobile terminal 100 by pressing any one of the objects 134A and 134B of the identifiers of the display unit 130.

[3-2. Processing from Displaying of Connection Information to User Input Synchronization/Release]

If the user decides the equipment serving as the manipulation target, the mobile terminal 100 transmits a connection message to the decided equipment. For example, as shown in FIG. 3, the button (the object 134B) of the identifier “2” displayed on the mobile terminal 100 is pressed. If so, the connection processing unit 120 of the mobile terminal 100 transmits the connection message of the format shown in FIG. 5 to the equipment 200B via the communication unit 110 so as to request the equipment 200B to establish the connection. The connection message includes the address M of the mobile terminal 100.

The equipment 200B receiving the connection message transmits a connection response message to the mobile terminal 100. The connection response message includes the address of the equipment 200B. If the mobile terminal 100 receives the connection response message, the actual connection starts and the user input from the mobile terminal 100 is synchronized with the equipment 200B (a user synchronization interval, which is also referred to as a “synchronization mode”).

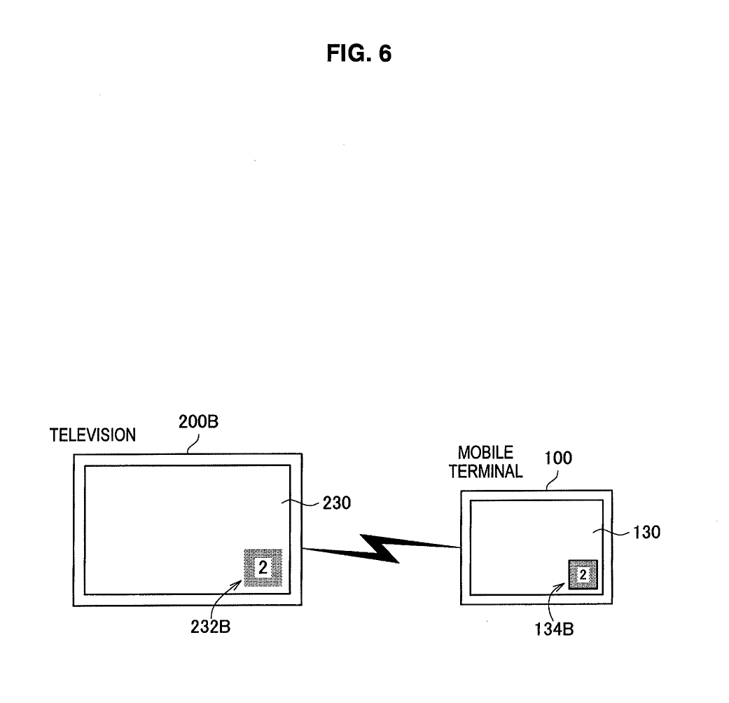

FIG. 6 is an explanatory diagram showing an example of a state in which an identifier is displayed on the television 200B and the mobile terminal 100. For example, in a state in which a connection between the mobile terminal 100 and the television 200B is established, the object 134B of the identifier “2” of the television 200B is displayed on the display unit 130 of the mobile terminal 100 as shown in FIG. 6. Together therewith, an object 232B of the identifier “2” of the television 200B is displayed on the visual display unit 230 of the television 200B. Thereby, the user can recognize the equipment capable of being manipulated by the mobile terminal 100.

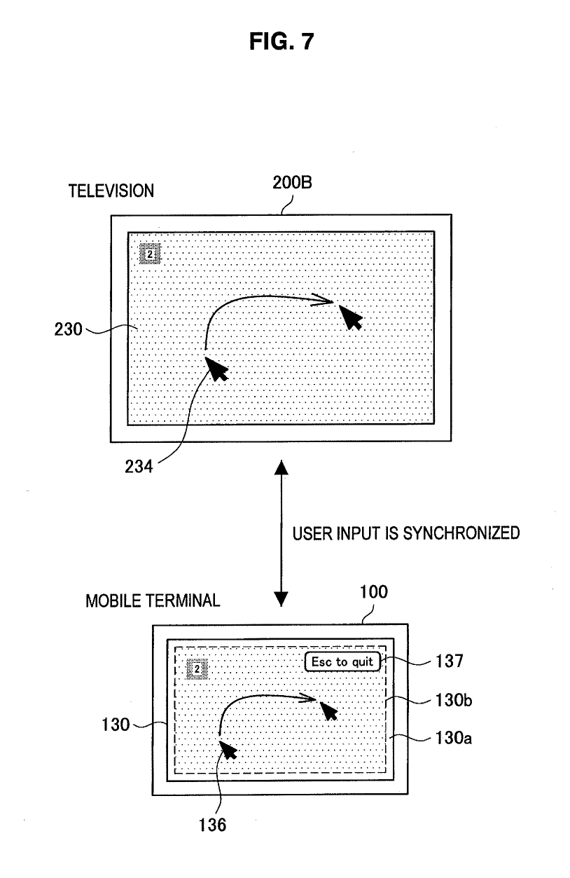

FIG. 7 shows a state in which a user input directed to the mobile terminal 100 is synchronized with manipulation of the television 200B after the television 200B is connected to the mobile terminal 100. In the mobile terminal 100 of FIG. 7, an equipment manipulation region 130b where the television 200B can be manipulated is set. The equipment manipulation region 130b is a predetermined region set in the display unit 130 as shown within the dashed line of FIG. 7. All manipulations within the equipment manipulation region 130b are transmitted to the television 200B.

For example, in the synchronization mode, a cursor 136 corresponding to a cursor 234 displayed on the display (also used as the visual display unit 230 in this embodiment) of the television 200B is displayed on the display unit 130 of the mobile terminal 100 of FIG. 7. At this time, if the user moves the cursor 136 displayed on the display unit 130 of the mobile terminal 100 by a finger, the manipulation input is also transmitted to the television 200B. The control unit 240 of the television 200B receiving the manipulation input directed to the mobile terminal 100 moves the cursor 234 displayed on the display based on the manipulation input. As such, the manipulation is input by the mobile terminal 100, so that the television 200B can be manipulated.

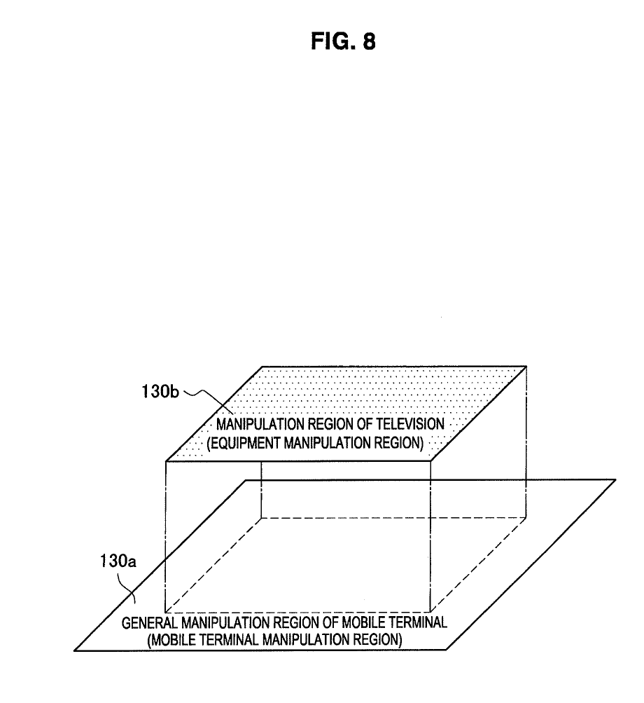

On the other hand, if manipulation is performed in a region outside the equipment manipulation region 130b, that is, a mobile terminal manipulation region 130a, the mobile terminal 100 is manipulated. That is, a screen configuration of the mobile terminal 100 includes a general manipulation region (the mobile terminal manipulation region 130a) of the mobile terminal 100 and a manipulation region (the equipment manipulation region 130b) of the television 200B, and the user may change a manipulation target by changing a region where the manipulation is input as shown in FIG. 8. As shown in FIG. 7, if an Esc button 137 of the mobile terminal 100 is pressed, the manipulation input directed to the television 200B may be terminated.

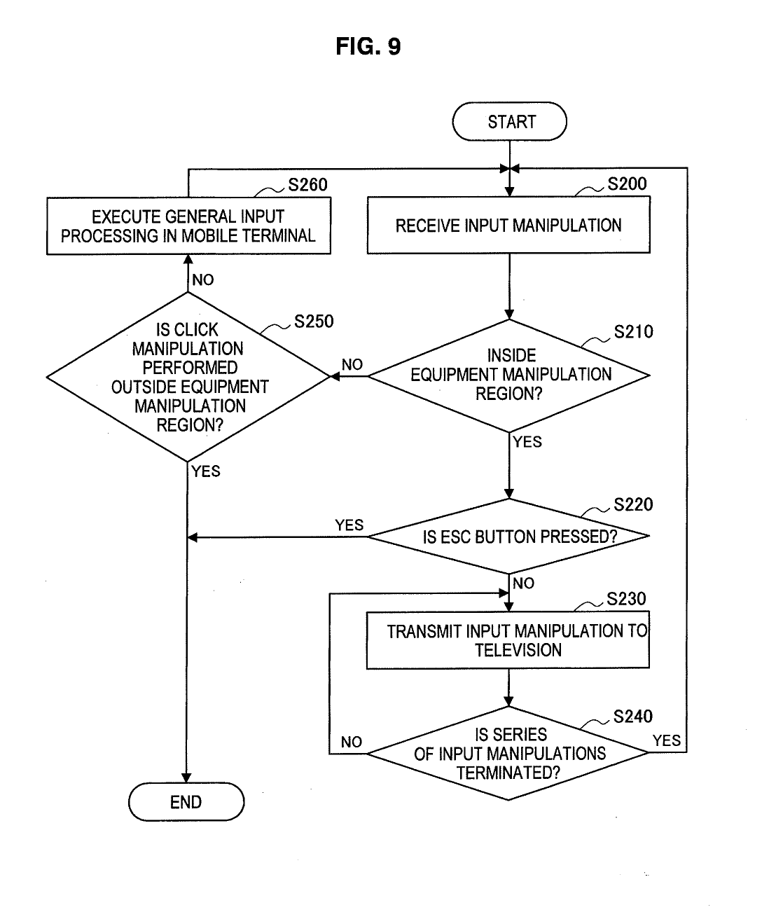

Processing during the synchronization mode will be described in detail based on FIG. 9. FIG. 9 is a flowchart showing processing of the mobile terminal 100 during the synchronization mode according to this embodiment. If the synchronization mode is reached, the mobile terminal 100 is in a state in which a user input from the input unit 140 is constantly received (S200). If the user input from the input unit 140 is made, the manipulation processing unit 150 determines whether or not a manipulation input is input in the equipment manipulation region 130b (S210). As shown in FIGS. 7 and 8 in this embodiment as described above, the screen of the mobile terminal 100 includes the mobile terminal manipulation region 130a and the equipment manipulation region 130b. In step S210, it is determined which equipment is to be manipulated by an input by determining a region where the manipulation input is performed.

If it is determined that input manipulation is performed within the equipment manipulation region 103b, the manipulation processing unit 150 confirms whether the Esc button 137 is pressed (S220). It is assumed that the Esc button 137 is provided within the equipment manipulation region 130b. If it is determined that the Esc button 137 is pressed in step S220, the mobile terminal 100 terminates the processing without manipulating the mobile terminal 100 or the television 200B. For example, as shown in FIG. 3, if the Esc button 137 is pressed, the mobile terminal 100 transmits a disconnection message including the address M of the mobile terminal 100 to the television 200B and terminates the synchronization mode.

On the other hand, if it is determined that the Esc button 137 is not pressed in step S220, the manipulation processing unit 150 transmits information of input manipulation to the television 200B via the communication unit 110 (S230). The television 200B receiving the information of the input manipulation performed by the mobile terminal 100 executes the manipulation processing of the television 200B based on the information. Thereby, the manipulation of the television 200B by the mobile terminal 100 is realized.

Thereafter, the manipulation processing unit 150 of the mobile terminal 100 determines whether or not a series of input manipulations for the input unit 140 is terminated (S240). The series of input manipulations may include, for example, manipulation of completing the movement of the cursor 136 by separating a finger from the display unit 130 after the user moves the cursor 136 displayed on the display unit 130 by the finger. When it is determined that the series of manipulations is terminated in step S240, for example, when the finger moving the cursor 136 is separated from the display unit 130 by moving the cursor 136, the manipulation processing unit 150 interrupts the transmission of information of the input manipulation to the television 200B once and returns to step S200. Step S200 and the subsequent processing are repeated by returning to a state in which the next input manipulation is received. This processing is repeated until the synchronization mode is terminated.

On the other hand, when it is determined that the series of input manipulations is not terminated in step S240, the manipulation processing unit 150 continuously transmits information of the input manipulation to the television 200B, and repeats the processing of steps S230 and S240.

Returning to the description of step S210, the manipulation processing unit 150 determines whether or not click manipulation is performed outside the equipment manipulation region 130b if it is determined that the manipulation input is input outside the equipment manipulation region 130b (S250). The processing of step S250 is to determine whether or not the input manipulation for terminating the manipulation of the television 200B is performed in the mobile terminal manipulation region 130a in this embodiment. The processing for terminating the manipulation of the television 200B may be the above-described click manipulation or another manipulation. If it is determined that the click manipulation is performed outside the equipment manipulation region 130b, the manipulation processing unit 150 transmits a disconnection message to the television 200B and terminates the synchronization mode like when the Esc button 137 is pressed in step S220.

On the other hand, if it is determined that the input manipulation for terminating the manipulation of the television 200B outside the equipment manipulation region 130b, for example, the click manipulation, is not performed, the manipulation processing unit 150 executes the input processing of the mobile terminal 100 based on the input manipulation input from the input unit 140 (S260). Thereafter, the mobile terminal 100 is in a state in which the input manipulation is received again (S200).

The processing of the mobile terminal 100 in the synchronization mode has been described above. The processing from the pressing of the connection button to the displaying of the connection information and the processing from the displaying of the connection information to the user input synchronization/release described based on FIGS. 3 to 9 are performed, so that settings for using the mobile terminal 100 as an input device of manipulation target equipment can be performed.

In order to use the mobile terminal 100 as the input device of the manipulation target equipment in the related art, it is necessary to perform device registration in the equipment in advance and it is necessary for the user to recognize an equipment name and select a connection target from a list. However, according to the information processing system of this embodiment, two manipulations of connection start manipulation and equipment selection manipulation are performed on the mobile terminal 100 without having to perform the device registration in advance, so that the mobile terminal 100 can be synchronized with the manipulation target equipment.

### 4. Modified Example

### 4-1. Screen Configuration of Mobile Terminal

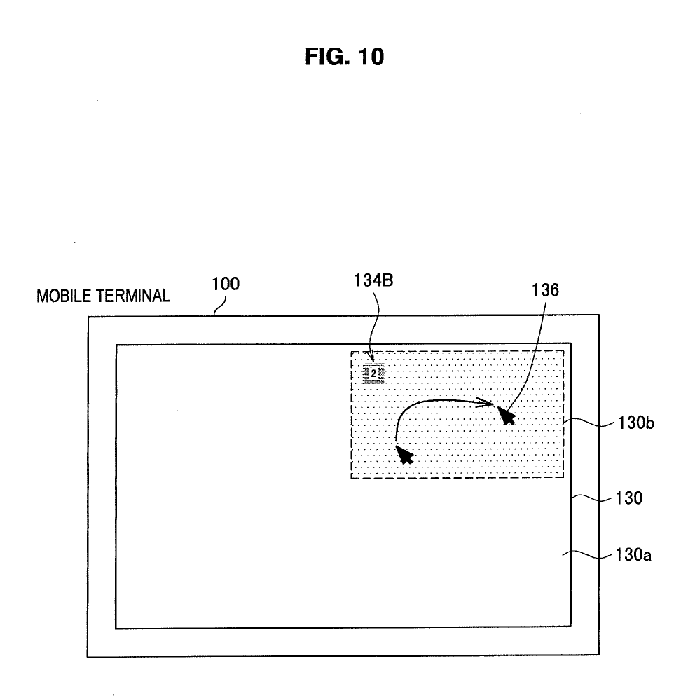

In the screen of the mobile terminal 100 shown in FIGS. 7 and 8, a major region excluding a peripheral portion of the display unit 130 is set as the equipment manipulation region 130b. However, original manipulation of the mobile terminal 100 and manipulation of the television 200 can be seamlessly switched by reducing the equipment manipulation region 130b. For example, manipulation in the mobile terminal manipulation region 130a and manipulation in the equipment manipulation region 130b can be easily switched within the display unit 130 by displaying the equipment manipulation region 130b on a right-top corner of the display unit 130 as shown in FIG. 10. As such, the screen of the mobile terminal 100 serving as the input device of the equipment can be appropriately set in consideration of manipulability.

### 4-2. Setting of Radio Wave Arrival Range

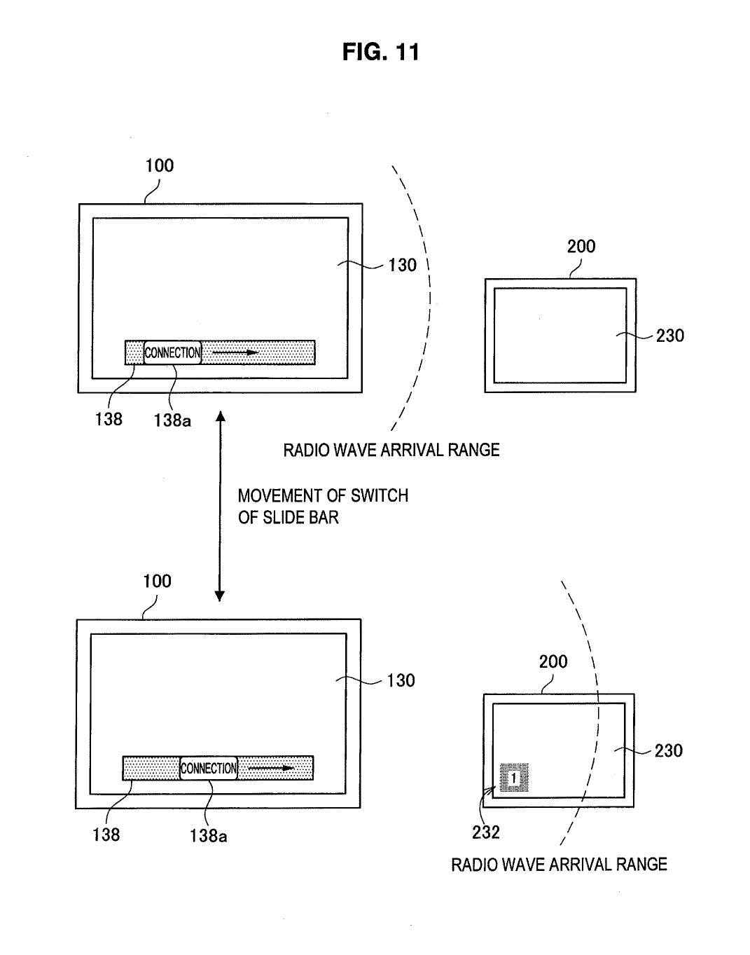

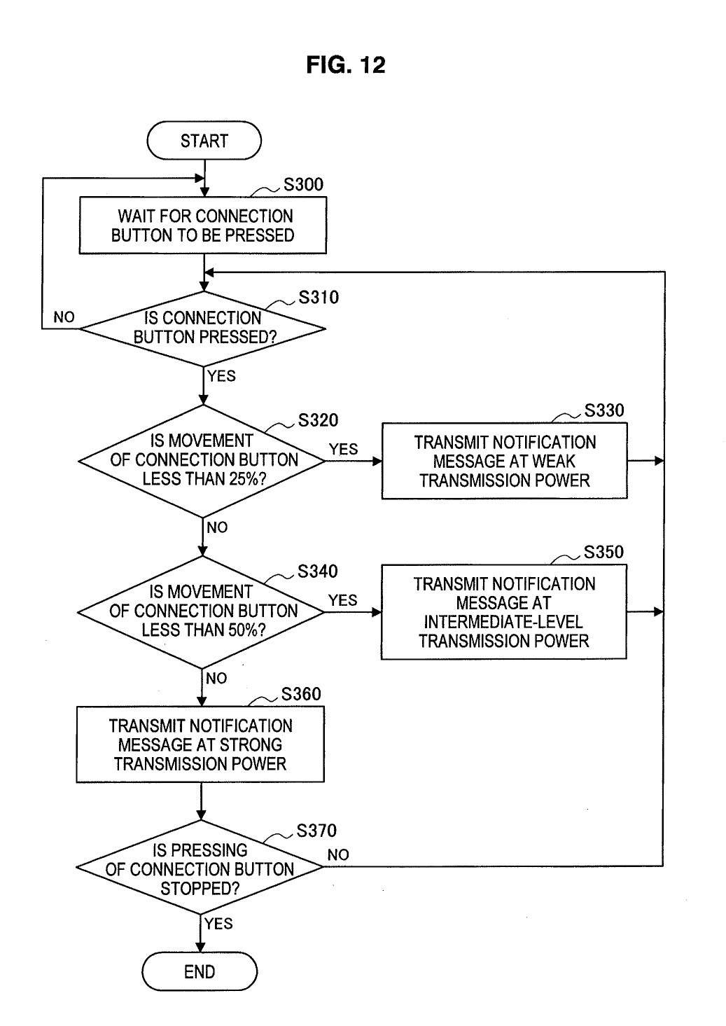

The mobile terminal 100 according to this embodiment may be configured to enable the radio wave arrival range output from the mobile terminal 100 to be changed. FIG. 11 is an explanatory diagram showing the radio wave arrival range of the mobile terminal 100. FIG. 12 is a flowchart showing processing of changing the radio wave arrival range in the mobile terminal 100.

As shown in the top figure of FIG. 11, the equipment 200, which does not exist within the radio wave arrival range from the mobile terminal 100, may not receive a notification message from the mobile terminal 100. Thus, the identifier of the equipment 200 is not displayed on the visual display unit 230. On the other hand, if the radio wave arrival range becomes wide and the equipment 200 is included in the range, the equipment 200 can receive a notification message from the mobile terminal 100. As shown in the lower figure of FIG. 11, an object 232 indicating the identifier of the equipment 200 is displayed on the visual display unit 230 of the equipment 200 receiving the notification message.

If the radio wave arrival range of the mobile terminal 100 is different as described above, the number of equipments to be detected is different in response to a position of controlled target equipment for the mobile terminal 100. If a number of equipments are present within the radio wave arrival range, selection is not easy and a possibility of wrong selection also exists, since the user should select the manipulation target equipment from a number of equipments. It is possible to easily find neighboring equipments serving as manipulation target candidates by enabling the radio wave arrival range of the mobile terminal 100 to be changed. For example, it is possible to prevent equipment that is not viewable from the mobile terminal 100 from being found.

For example, as shown in FIG. 11, the change of the radio wave arrival range of the mobile terminal 100 may be performed by a slide bar 138 displayed on the display unit 130 of the mobile terminal 100. For example, transmission power is designated as 0% when a switch 138a is located on the left of the slide bar 138, and the transmission power is designated as 100% when the switch 138a is located on the right of the slide bar 138. That is, the radio wave arrival range becomes narrow when the switch 138a moves to the left, and the radio wave arrival range becomes wide when the switch 138a moves to the right. The magnitude of transmission power is changed in response to a movement distance of the switch 138a from a reference position in the slide bar 138. As shown in FIG. 11, the switch 138a of the slide bar 138 may be used as the connection button by which the transmission of the notification message is started.

For example, the change of the radio wave arrival range in the mobile terminal as described above may be made as shown in FIG. 12. First, the mobile terminal 100 waits for the connection button to be pressed to transmit the notification message (S300). The connection processing unit 120 confirms whether or not the connection button is pressed at a predetermined timing (S310), and the processing of steps S300 and S310 is repeated until the connection button is pressed.

If the connection button is pressed, the connection processing unit 120 confirms a position of the connection button in the slide bar 138, and decides the magnitude of transmission power at which the notification message is transmitted in response to the position. In this example, the transmission power is changed in three steps. As described above, the magnitude of transmission power is decided in response to a ratio of a movement distance of the connection button (the switch 138a) from a reference position with respect to a total length of the slide bar 138 by designating a left end of the slide bar 138 as the reference position. The mobile terminal 100 transmits the notification message at first transmission power when the ratio is less than 25%, and transmits the notification message at second transmission power, which is greater than the first transmission power, when the ratio is equal to or greater than 25% and less than 50%. When the ratio is equal to or greater than 50%, the mobile terminal 100 transmits the notification message at third transmission power, which is greater than the second transmission power. Thereby, it is possible to set three radio wave arrival ranges of a small area, an intermediate area, and a wide area.

As shown in FIG. 12, the connection processing unit 120 of the mobile terminal 100 determines whether or not the movement distance of the connection button is less than 25% of the total length of the slide bar 138 (S320). If the movement distance is less than 25%, the connection processing unit 120 transmits the notification message to the equipment 200 at the first transmission power, which is weakest (S330). By returning to step S310, it is confirmed whether or not the movement manipulation of the connection button is continuously performed and the magnitude of transmission power at which the notification message is transmitted is set while the connection button moves.

If the ratio of the movement distance of the connection button is equal to or greater than 25% with respect to the total length of the slide bar 138 in step S320, the connection processing unit 120 next determines whether or not the ratio is less than 50% (S340). If the ratio is less than 50%, the connection processing unit 120 transmits the notification message to the equipment 200 at the second transmission power having an intermediate level (S350). By returning to step S310, it is confirmed whether or not the movement manipulation of the connection button is continuously performed and the magnitude of transmission power at which the notification message is transmitted is set while the connection button moves.

If the ratio of the movement distance of the connection button is equal to or greater than 50% with respect to the total length of the slide bar 138 in step S340, the connection processing unit 120 transmits the notification message to the equipment 200 at the third transmission power, which is strongest (S360). The connection processing unit 120 confirms whether or not the pressing of the connection button is stopped (S370), returns to step S310 if the pressing continues, and repeats the processing from step S310. On the other hand, if it is determined that the pressing of the connection button is stopped, the connection processing unit 120 terminates the processing of changing the ratio wave arrival range.

Manipulation target equipment can be easily found by changing the radio wave arrival range as described above.

### 5. Hardware Configuration Example

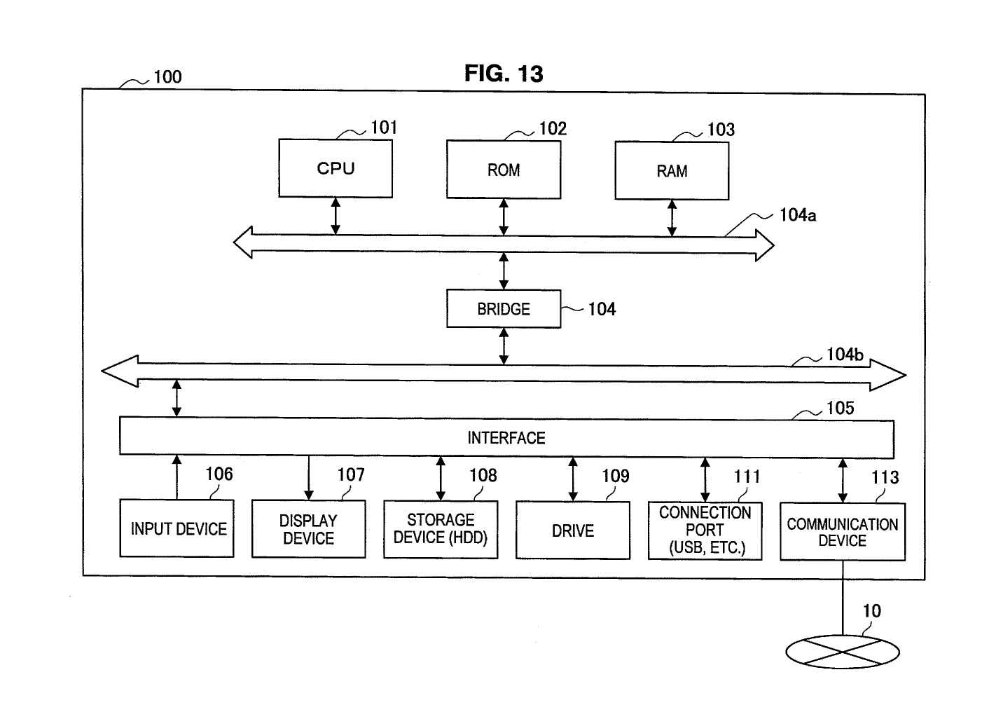

The processing by the mobile terminal 100 according to this embodiment may be executed by hardware or software. In this case, the mobile terminal 100 can be configured as a computer as shown in FIG. 13. Hereinafter, a hardware configuration example of the mobile terminal 100 will be described based on FIG. 13.

The mobile terminal 100 according to this embodiment can be realized by a processing device such as a computer as described above. As shown in FIG. 13, the mobile terminal 100 includes a central processing unit (CPU) 101, a read only memory (ROM) 102, a random access memory (RAM) 103, and a host bus 104a. The mobile terminal 100 includes a bridge 104, an external bus 104b, an interface 105, an input device 106, an output device 107, a storage device (HDD) 108, a drive 109, a connection port 111, and a communication device 113.

The CPU 101 functions as an arithmetic processing device and a control device, and controls the overall operation within the mobile terminal 100 according to various types of programs. The CPU 101 may be a microprocessor. The ROM 102 stores programs, arithmetic parameters, or the like to be used by the CPU 101. The RAM 103 temporarily stores programs used for execution in the CPU 101, parameters, which appropriately vary in the execution, or the like. They are connected to each other by the host bus 104a including a CPU bus or the like.

The host bus 104a is connected to the external bus 104b such as a peripheral component interconnect/interface (PCI) bus via the bridge 104. The host bus 104a, the bridge 104, and the external bus 104b are not necessarily separately configured and their functions may be installed in one bus.

The input device 106 includes input units for allowing the user to input information such as a mouse, a keyboard, a touch panel, a button, a microphone, a switch, or a lever, and an input control circuit, which generates an input signal based on an input by the user and outputs the input signal to the CPU 101. For example, the output device 107 includes a display device such as a liquid crystal display (LCD) device, an organic light emitting diode (OLED) device, or a lamp or an audio output device such as a speaker.

The storage device 108 is an example of a storage unit of the mobile terminal 100, and is a device for storing data. The storage device 108 may include a tangibly embodied non-transitory computer-readable storage medium, a recording device, which records data on the storage medium, a reading device, which reads data from the storage medium, or an erasing device, which erases data recorded on the storage medium. For example, the storage device 108 includes a hard disk drive (HDD). The storage device 108 drives a hard disk and stores programs or instructions to be executed by the CPU 101 or various types of data.

The drive 109 is a reader/writer for a storage medium, and is built in or attached to the outside of the mobile terminal 100 or attached to the outside. The drive 109 reads information recorded on a magnetic disk, an optical disc, a magneto optical disc, or a removal recording medium such as a semiconductor memory, and outputs the information to the RAM 103.

For example, the connection port 111 is an interface connected to the external equipment, and is a connection port of external equipment to which data can be transmitted by, for example, a universal serial bus (USB) or the like. For example, the communication device 113 is a communication interface constituted by a communication device for establishing a connection to a communication network 10. The communication device 113 may be a communication device corresponding to a wireless local area network (LAN), a communication device corresponding to a wireless USB, or a wired communication device, which performs wired communication.

Exemplary embodiments have been described above in detail with reference to the appended drawings, but embodiments are not limited thereto. It should be understood by those skilled in the art that various modifications, combinations, sub-combinations and alterations may occur depending on design requirements and other factors insofar as they are within the scope of the appended claims or the equivalents thereof.

An example in which a decision of equipment serving as a manipulation target is displayed on the display unit 130 in combination with a selection button capable of being pressed and is performed by pressing an identifier of connectable equipment has been described in the above-described embodiment, but embodiments are not limited to this example. For example, an indication indicating an existing button in the mobile terminal 100 is displayed on the visual display unit 230 of a manipulation target candidate, thereby presenting a method of selecting the equipment serving as the manipulation target. That is, the same information as information displayed on the visual display unit 230 of the equipment exists in the mobile terminal 100, so that the user can easily select desired equipment. In this case, the display unit 130 is not necessarily provided in the mobile terminal 100, which is control equipment.

An example in which a display of the television 200, which is controlled equipment, is used as the visual display unit 230 on which its own identifier is displayed has been described in the above-described embodiment, but embodiments are not limited to this example. For example, it is preferable that the visual display unit 230 be provided in the controlled equipment and allow the user to visually identify its own equipment. A light emitting unit of LEDs can be used. In this case, for example, LEDs of different colors are respectively provided in each controlled equipment. Equipment receiving a notification message from the mobile terminal 100 causes the LEDs, which are the visual display unit 230, to emit light, and transmits a response message to the mobile terminal 100.

In the display unit 130 of the mobile terminal 100 receiving the response message, an LED color of the equipment transmitting the response message is displayed by a character or hue. Thereby, the user can specify manipulation target equipment by comparing information displayed on the mobile terminal 100 to the LEDs of the controlled equipments.

Further, an example in which the television 200 is manipulated through the mobile terminal 100 has been described in the above-described embodiment, but embodiments are not limited to this example. For example, the information processing system is applicable even when the mobile terminal 100 and the controlled equipment are a web browser-based system. In this case, it is preferable that message transmission/reception for entering the synchronization mode be performed based on HTTP.

What is claimed is:

1. An apparatus, comprising:
an input unit for receiving user input indicating a request to connect to a controllable device; and
a communication unit for transmitting information to a plurality of controllable devices having indicators, the transmitted information including a command for causing the controllable devices to display, on the indicators, identifiers corresponding to the controllable devices.

2. The apparatus of claim 1, comprising a display unit for displaying identifiers corresponding to the controllable devices, based on response messages received from the controllable devices.

3. The apparatus of claim 2, wherein:
receiving user input comprises receiving input of a selection of one of the displayed identifiers; and
transmitting information comprises transmitting a connection message to a controllable device associated with the selected identifier.

4. The apparatus of claim 3, comprising a connection processing unit for:
establishing, upon receipt of a response to the connection message from the controllable device associated with the selected identifier, a connection with the controllable device associated with the selected identifier;
generating command signals corresponding to the user input, the command signals being executable by the controllable device associated with the selected identifier;
supplying the command signals to the communication unit for transmission to the controllable device associated with the selected identifier; and
generating display signals causing the display unit to display indications of the command signals.

5. The apparatus of claim 4, wherein the display unit comprises a plurality of subset regions, and the connection processing unit generates signals according to user input received in a first one of the subset regions.

6. The apparatus of claim 1, wherein:
the display unit displays a control graphic;
the input unit receives user input directed to the control graphic; and
the communication unit adjusts transmission power of the communication unit in response to the received user input directed to the control graphic.

7. An apparatus controllable by a control device, comprising:
a communication unit for receiving a notification message from a control device; and
a display unit for displaying an identifier of the apparatus on an indicator of the apparatus, in response to receipt of the notification message.

8. The apparatus of claim 7, wherein the communication unit transmits to the control device, in response to the notification message, a response message including an identifier of the apparatus.

9. The apparatus of claim 7, wherein the control device uses the identifier to control the apparatus.

10. A method for controlling devices, comprising:
receiving user input indicating a request to connect to a controllable device; and
transmitting information to a plurality of controllable devices having indicators, the transmitted information including a command for causing the controllable devices to display, on the indicators, identifiers corresponding to the controllable devices.

11. A tangibly embodied non-transitory computer-readable storage device storing instructions which, when executed by a processor, cause a computer to perform a method for controlling devices, comprising:
receiving user input indicating a request to connect to a controllable device; and
transmitting information to a plurality of controllable devices having indicators, the transmitted information including a command for causing the controllable devices to display, on the indicators, identifiers corresponding to the controllable devices.

12. A system, comprising:
a controlling unit for:
receiving user input indicating a request to connect to a controllable unit; and
transmitting information to a plurality of controllable units having indicators, the transmitted information including a command for causing the controllable units to display, on the indicators, identifiers corresponding to the controllable units; and
a controllable unit for:
receiving the transmitted information including the command from a controlling unit; and
displaying an identifier of the controllable unit on an indicator of the controllable unit, in response to the command.
